(19) United States
(12) Patent Application Publication
(10) Pub. No.: US 2026/0214470 A1
(43) Pub. Date: Jul. 23, 2026

(54) METHOD OF gNB-UE BEHAVIORS FOR MODEL-BASED MOBILITY

(71) Applicant: Continental Automotive Technologies GmbH, Hannover (DE)

(72) Inventors: Hojin Kim, Regensburg (DE); Rikin Shah, Langen, Hessen (DE); Reuben George Stephen, Singapore (SG)

(73) Assignee: Continental Automotive Technologies GmbH, Hannover (DE)

(21) Appl. No.: 19/145,021

(22) PCT Filed: Feb. 1, 2024
(86) PCT No.: PCT/EP2024/052537

§ 371 Date: Jul. 1, 2025

(30) Foreign Application Priority Data
Feb. 3, 2023 (DE) 10 2023 200 909.9

(51) Int. Cl. H04W 24/02; H04W 36/08

(52) U.S. Cl. CPC H04W 24/02; H04W 36/08

(57) ABSTRACT

The present disclosure describes methods of pre-configuring AI/ML based model before handover occurs in wireless mobile communication system including base station and mobile station. An AI/ML model is applied to radio access network, model performance such as inferencing and/or training is dependent on different model execution environment with varying configuration parameters. Therefore, by re-configuring any model in operation with source gNB in advance, the performance impact due to UE mobility can be minimized when target gNB connection is made.

### CROSS-REFERENCE TO RELATED APPLICATIONS

This application is the U.S. National Phase Application of PCT International Application No. PCT/EP2024/052537, filed Feb. 1, 2024, which claims priority to German Patent Application No. 10 2023 200 909.9, filed Feb. 3, 2023, the contents of such applications being incorporated by reference herein.

### TECHNICAL FIELD

The present disclosure relates to AI/ML based model pre-configuration, where techniques for re-configuring and signaling the specific information to avoid model performance degradation due to UE mobility are presented.

### BACKGROUND

In December 2021, the release-18 package of 3GPP (Third Generation Partnership Project) has been approved and one of the selected study items is AI/ML (artificial intelligence/machine learning) as described in the related document (RP-213599) addressed in 3GPP TSG (Technical Specification Group) RAN (Radio Access Network) meeting #94e. The official title of AI/ML study item is “Study on AI/ML for NR Air Interface”, and currently RAN WG1 (Working Group 1) and WG2 are actively working on specification. The goal of this study item is to identify a common AI/ML framework and areas of obtaining gains using AI/ML based techniques with use cases. In radio access network perspective, one of key areas for work scope is to identify various levels of collaboration between base station (BS/gNB) and user equipment (UE).

According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc. Earlier, in 3GPP TR 37.817 for Release 17, titled as Study on enhancement for Data Collection for NR and EN-DC, UE mobility was also considered as one of AI/ML use cases and one of scenarios for model training/inference is that both functions are located within RAN node. Followingly, in Release 18 the new work item of “Artificial Intelligence (AI)/Machine Learning (ML) for NG-RAN” was initiated to specify data collection enhancements and signaling support within existing NG-RAN interfaces and architecture where mobility optimization is included as one of target tasks.

For the above active standardization works, UE mobility to support RAN-based AI/ML model can be considered very significant for both gNB and UE to meet any desired model operations (e.g., model training/inference/selection/switching/update/monitoring, etc.) when UE moves around. Currently, there is no specification defined for signaling methods or gNB-UE behaviors about UE mobility when RAN-based AI/ML model operation proceeds. Therefore, it is necessary to investigate any specification impact by considering model operation during UE mobility. Any mechanism of additional signaling method and/or gNB-UE behaviors also need to be addressed to support mobility-based model operation between gNB and UE so that any potential impact of UE mobility on model operation in RAN should be minimized with service continuity.

On the other hand, in 3GPP the terminologies of working list contain a set of high-level descriptions about AI/ML model training, inference, validation, testing, UE-side model, network-side model, one-sided model, two-sided model, etc. UE-sided model and network-sided model indicate that AI/ML model is located for operation in UE and network side, respectively. In the similar context, one-sided and two-sided model indicate that AI/ML model is located in one side and two sides, respectively.

All signaling aspects to support the above items are currently not specified yet as definitions of terminologies are still under discussion for further modifications. Any potential standards impact with new or enhanced mechanisms of supporting AI/ML model with the above working list items is one of key areas for investigation in AI/ML study item.

WO 2022034259, incorporated herein by reference, describes a network apparatus that is caused to receive as part of a handover procedure for handover of a terminal to the network apparatus.

WO 2022058020, incorporated herein by reference, describes measures for evaluation and control of predictive machine learning models in mobile networks.

WO 2022199824, incorporated herein by reference, describes the method establishing a first wireless access radio link between a first access node and a wireless device.

WO 2022258196, incorporated herein by reference, describes means for receiving a machine learning model for predicting handover parameters.

WO 2021123285, incorporated herein by reference, contains description of determining, based on an output of the model, that the communications device should perform a handover to establish a connection in a second cell.

WO 2021259492, incorporated herein by reference, describes a method in a first node of a communications network for training a machine learning model comprises receiving a first message comprising instructions for training the machine learning model using a distributed learning process.

### SUMMARY OF THE INVENTION

The addressed problem is solved by the features of the claims.

The pre-configured model operation for connection with target gNB is determined for UE in advance before UE mobility execution so that any model performance impact due to UE mobility can be minimized. This means the model performance degradation impact due to UE mobility is reduced and model operation-related signaling overhead is reduced.

According to a first aspect, the present disclosure relates to a method of gNB-UE behaviors for model-based mobility with a pre-configuring AI/ML model based on either full pre-configuration or partial pre-configuration, wherein for full pre-configured AI/ML model, the re-configured model is fully loaded to UE before handover execution, for partial pre-configuration of AI/ML model, the re-configured model is partially loaded to UE before handover execution.

In some embodiments of the method according to the first aspect, the method is characterized by, that determination of transmitting full or partial model pre-configuration information is based on network/UE-specific criteria.

In some embodiments of the method according to the first aspect, the method is characterized by, that network/UE-specific criteria are UE ML capability state and/or model type and/or functionalities, and/or network data traffic status and/or model-based service application.

In some embodiments of the method according to the first aspect, the method is characterized by, that source gNB gets the latest information about UE model operation so that any required model re-configuration between gNB and UE is made by obtaining the model operation status updates from UE with device model status information signaling.

In some embodiments of the method according to the first aspect, the method is characterized by, that device model status information contains the categorized data types like model operation mode state and/or model training state and/or model inference state and/or model update state and/or model monitoring state and/or model ID and/or ML capability state and the structure of device model status information is flexibly configured or sub-categorized through RRC signaling and device model status information is sent to gNB from UE through PUCCH/PUSCH or MAC CE.

In some embodiments of the method according to the first aspect, the method is characterized by, that UE pre-loads the re-configured model in advance for new connection with target gNB based on the received signaling of model pre-configuration information from source gNB.

In some embodiments of the method according to the first aspect, the method is characterized by, that model pre-configuration information contains such as model configuration parameters, model ID, model transfer type, model lifecycle type, whereby model pre-configuration information is sent to UE from gNB through PDCCH/PDSCH or MAC CE.

In some embodiments of the method according to the first aspect, the method is characterized by, that model pre-configuration information can be structured into multiple partitions so that partial/fractional re-configuration can be applied well as full re-configuration for pre-loading.

In some embodiments of the method according to the first aspect, the method is characterized by, that based on the content of model pre-configuration information, those can be partitioned into common attributes and UE-specific attributes so that any combination of model pre-configuration information can be provided to UE if necessary.

In some embodiments of the method according to the first aspect, the method is characterized by, that a super set of model pre-configuration information is maintained in source gNB or network side.

In some embodiments of the method according to the first aspect, the method is characterized by, that different levels of model re-configuration is performed based on different conditions and environments of model operation.

In some embodiments of the method according to the first aspect, the method is characterized by, that the necessity of UE model re-configuration is determined depending on location of model activation (e.g., network side or UE side or both).

In some embodiments of the method according to the first aspect, the method is characterized by, that location of model activation is on network side and/or UE side.

In some embodiments of the method according to the first aspect, the method is characterized by, that model in network side only, no UE model re-configuration is executed and assistance information signaling from UE might be still needed. Model re-configuration request need to be sent to target gNB(s) or network side.

In some embodiments of the method according to the first aspect, the method is characterized by, that for model in UE side only or models in network-UE sides, full or partial/fractional re-configuration to UE model is executed and model re-configuration request also is to be sent to target gNB(s) or network side when there is a model activation in network side for re-configuration.

In some embodiments of the method according to the first aspect, the method is characterized by, that source gNB determines high mobility-UE, which will be indicated for model re-configuration, which is based on AI/ML model repository from network in preparation for handover to other target gNB by monitoring mobility status of UEs and high mobility-UEs are identified using mobility pattern information with historical measurement data.

In some embodiments of the method according to the first aspect, the method is characterized by, that for high mobility UE with the pre-loaded model re-configuration, the model deactivation timer is applied so that network and/or UE resource is less burdened when handover does not occur.

In some embodiments of the method according to the first aspect, the method is characterized by, that with the expiry of the model deactivation timer, high mobility UE unloads the pre-configured model as this UE makes no handover.

In some embodiments of the method according to the first aspect, the method is characterized by, that for general/normal handover case, RRC reconfiguration through handover command signaling indicates target gNB information by triggering activation of the pre-configured model and additional model pre-configuration information if necessary, after confirming handover the pre-configured model is enabled beforehand for connection with target gNB.

In some embodiments of the method according to the first aspect, the method is characterized by, that for advanced handover case (conditional handover—CHO), in source gNB, candidate target gNBs are prioritized for UE connection in advance so that any model-related signaling overhead and UE mobility-based model impact is minimized.

In some embodiments of the method according to the first aspect, the method is characterized by, that CHO based RRC reconfiguration signaling indicates additional new information about additional model pre-configuration information associated with the prioritized list of target gNBs.

In some embodiments of the method according to the first aspect, the method is characterized by, that after CHO condition is met, the pre-configured model is enabled beforehand for connection with target gNB.

In some embodiments of the method according to the first aspect, the method is characterized by, that a set of resources need to be reserved in target gNBs during UE mobility execution with model support and source gNB maintains the prioritized list of target gNBs and the associated model pre-configuration instruction to be signaled to high mobility UE.

According to a second aspect, the present disclosure relates to a wireless device comprising at least one memory and at least one processor configured to carry out a method according to any one of the embodiments of the first aspect.

According to a third aspect, the present disclosure relates to a user equipment, UE, comprising a wireless device according to any one of the embodiments of the present disclosure.

According to a fourth aspect, the present disclosure relates to a base station, BS, comprising at least one memory and at least one processor configured to carry out a method according to any one of the embodiments of the first aspect.

According to a fifth aspect, the present disclosure relates to a wireless communication system comprising at least one base station according to any one of the embodiments of the present disclosure and at least one user equipment according to any one of the embodiments of the present disclosure.

According to a sixth aspect, the present disclosure relates to a computer program product comprising instructions which, when executed by at least one processor, configure said at least one processor to carry out a method according to the first aspect said at least one processor to carry out a method for exchanging data according to any one of the embodiments of the present disclosure. The computer program product can use any programming language, and can be in the form of source code, object code, or in any intermediate form between source code and object code, such as in a partially compiled form, or in any other desirable form.

According to a seventh aspect, the present disclosure relates to a computer-readable storage medium comprising instructions which, when executed by at least one processor, configure said at least one processor to carry out a method according to any one of the embodiments of the present disclosure.

### BRIEF DESCRIPTION OF THE DRAWINGS

FIG. 1 shows an exemplary table of the content of device model status information.

FIG. 2 shows a signaling flow of device model status information.

FIG. 3 shows an exemplary table of the content of model pre-configuration information.

FIG. 4 shows a signaling flow of model pre-configuration information.

FIG. 5 shows a flow chart of gNB behavior for pre-configuration model.

FIG. 6 shows a flow chart of UE behavior for pre-configuration model.

FIG. 7 shows a block diagram of multiple partitioning of model pre-configuration information.

FIG. 8 shows a flow chart of model re-configuration for UE side.

FIG. 9 shows a flow chart of model re-configuration for network side.

FIG. 10 shows a flow chart of UE mobility detection.

FIG. 11 shows a flow chart of UE mobility monitoring.

FIG. 12 shows a signaling flow of pre-configured model for general handover case.

FIG. 13 shows a signaling flow of pre-configured model for conditional handover (CHO) case.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of aspects of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Also, the order of steps of any methods disclosed herein, in particular in the figures, is provided only for illustration purposes and is not meant to limit the present disclosure which may be applied with the same steps executed in a different order and/or with all or part of the steps executed in parallel or jointly, unless a step is explicitly described as following or preceding another step and/or where it is implicit that a step must follow or precede another step. Also, in a figure, steps represented surrounded by a dashed line are to be considered as optional for the embodiment represented in this figure. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about pre-configuring AI/ML-based model before handover occurrence in radio access network. AI/ML based techniques are currently applied to many different applications and 3GPP also started to work on its technical investigation to apply to multiple use cases based on the observed potential gains. AI/ML lifecycle can be split into several stages such as data collection/pre-processing, model training, model testing/validation, model deployment/update, model monitoring etc., where each stage is equally important to achieve target performance with any specific model(s).

In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input. In a similar aspect, the statistical property of dataset and the relationship between input and output for the trained model can be changed with drift occurrence. In this context, UE mobility is one of key issues for model performance maintenance as model performance such as inferencing and/or training is dependent on different model execution environment with varying configuration parameters.

To handle this issue, collaboration between UE and gNB is highly important to track model performance and re-configure model corresponding to different environments as UE moves around across different gNBs. AI/ML model needs model monitoring after deployment because model performance cannot be maintained continuously due to drift and update feedback is then provided to re-train/update the model or select alternative model. Therefore, AI/ML data/model drift handling is highly important by tracking model performance such as predictability, accuracy, etc.

When AI/ML model enabled wireless communication network is deployed, it is then important to consider how to handle AI/ML model in activation with re-configuration for wireless devices under operations such as model training, inference, updating, etc. In other words, by re-configuring any model in operation with source gNB in advance, the performance impact due to UE mobility can be minimized when target gNB connection is made.

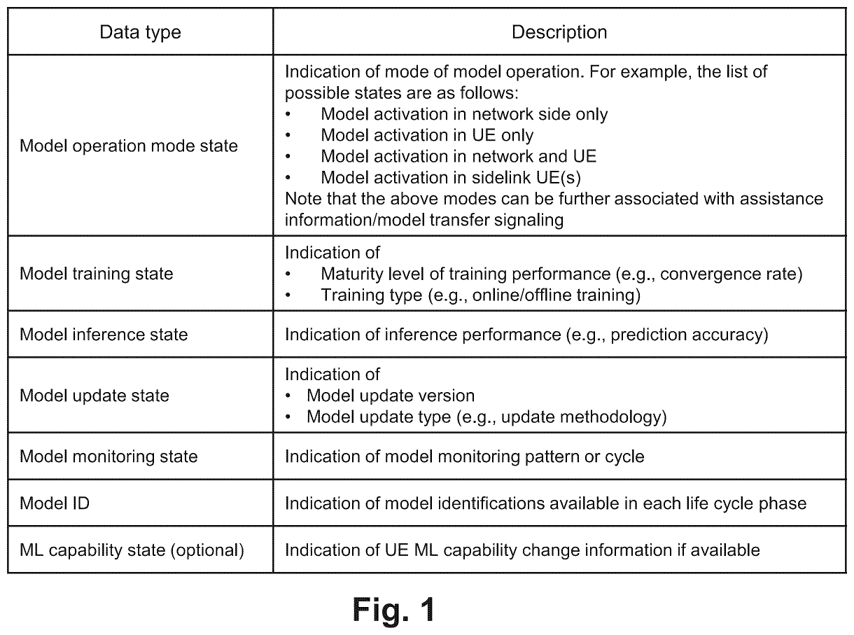

FIG. 1 shows an exemplary table of the content of device model status information that is provided by UE. Based on the model operation status updates from UE using “device model status information”, source gNB gets the latest information about UE model operation so that any required model re-configuration between gNB and UE can be made if necessary. Device model status information contains the categorized data types such as {model operation mode state, model training state, model inference state, model update state, model monitoring state, model ID, ML capability state}. The structure of device model status information can be flexibly configured or sub-categorized through radio resource control (RRC) signaling.

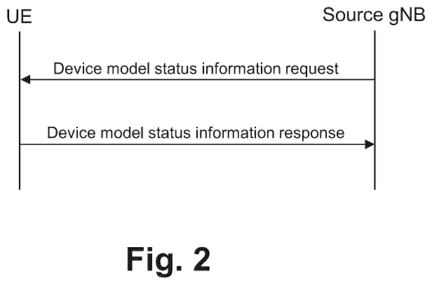

FIG. 2 describes a signaling flow of device model status information. Device model status information can be sent to gNB from UE through PUCCH/PUSCH or MAC CE. In scheduling perspective, this information signaling can be configured to be periodic, semi-persistent, or aperiodic as well.

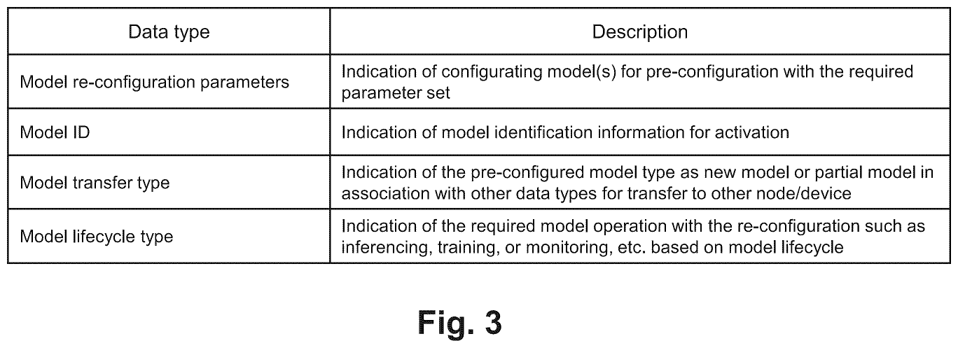

FIG. 3 shows an exemplary table of the content of model pre-configuration information. Signaling of “model pre-configuration information” is used to pre-load the re-configured model in advance for new connection with target gNB. Model pre-configuration information contains such as {model configuration parameters, model ID, model transfer type, model lifecycle type}.

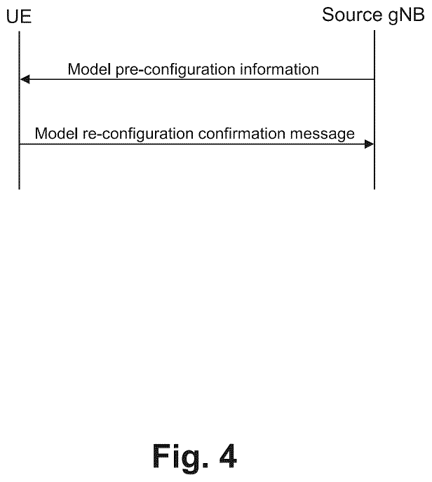

FIG. 4 describes a signaling flow of model pre-configuration information. Model pre-configuration information can be sent to UE from gNB through PDCCH/PDSCH or MAC CE. In scheduling perspective, this information signaling can be configured to be periodic, semi-persistent, or aperiodic as well.

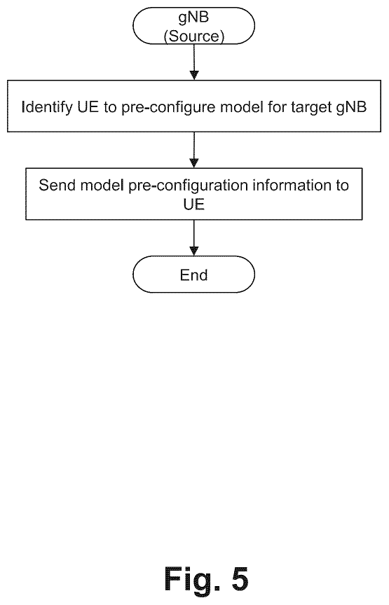

FIG. 5 shows a flow chart of gNB behavior for pre-configuration model. The pre-configured model for preparation can be based on two scenarios. In first scenario, full pre-configuration of AI/ML model is considered, in which the re-configured model is fully loaded to UE before handover execution. In second scenario, partial pre-configuration of AI/ML model is considered, in which the re-configured model is partially loaded to UE before handover execution. Regarding how to determine full or partial model pre-configuration information can be based on network/UE-specific criteria. For example, it depends on UE ML capability state, model type or functionalities, network data traffic status and/or model-based service application, etc.

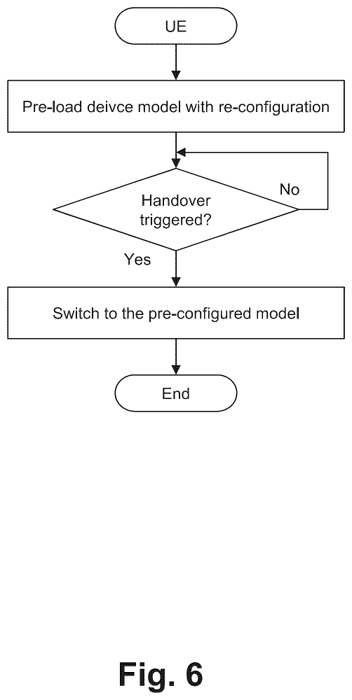

FIG. 6 shows a flow chart of UE behavior for pre-configuration model. On UE side, the re-configured model is pre-loaded so that it can be activated for use when handover is triggered. After handover is triggered, UE switches to the pre-configured model for operation. In implementation perspective, the timing of pre-loading and/or operation switching can vary. In other words, pre-loading can happen after handover triggering as well and consecutively operation switching follows, for example.

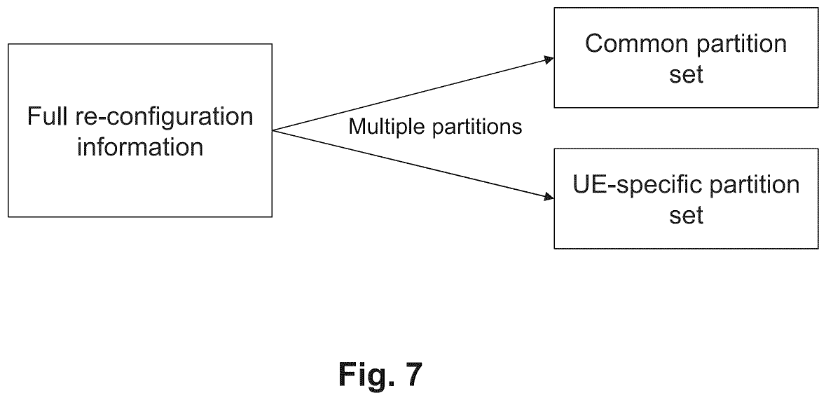

FIG. 7 describes a block diagram of multiple partitioning of model pre-configuration information. For model pre-configuration information, it can be structured into multiple partitions so that partial/fractional re-configuration can be applied well as full re-configuration for pre-loading. Based on the content of model pre-configuration information, those can be partitioned into common attributes and UE-specific attributes so that any combination of model pre-configuration information can be provided to UE if necessary. A super set of model pre-configuration information is maintained in source gNB or network side. Therefore, different levels of model re-configuration can be performed based on different conditions and environments of model operation.

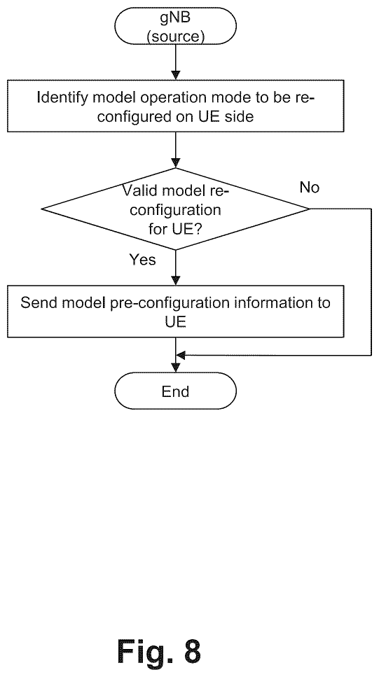

FIG. 8 shows a flow chart of model re-configuration for UE side. Depending on location of model activation (e.g., network side or UE side or both), the necessity of UE model re-configuration is determined. For example, if model is located in UE side only or models in available in both network and UE sides, full or partial/fractional re-configuration to UE model is necessary. In case there is a model activation in network side for re-configuration, model re-configuration request also need to be sent to target gNB(s) or network side.

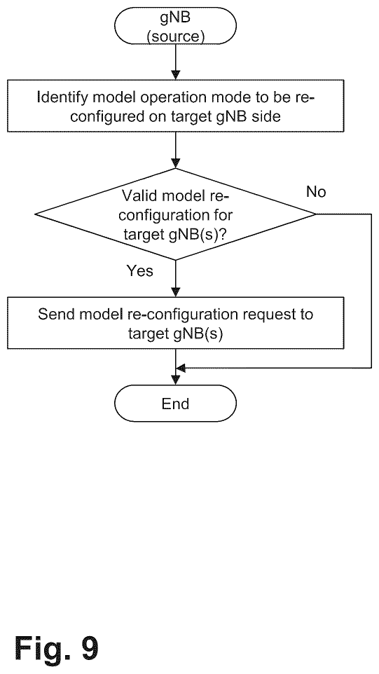

FIG. 9 shows a flow chart of model re-configuration for network side. For example, if model is located in network side only, no UE model re-configuration is necessary. However, assistance information signaling from UE might be still needed. In this case, model re-configuration request need to be sent to target gNB(s) or network side so that any potential UE for handover to the indicated target gNB can continue to be served with model operation in target gNB.

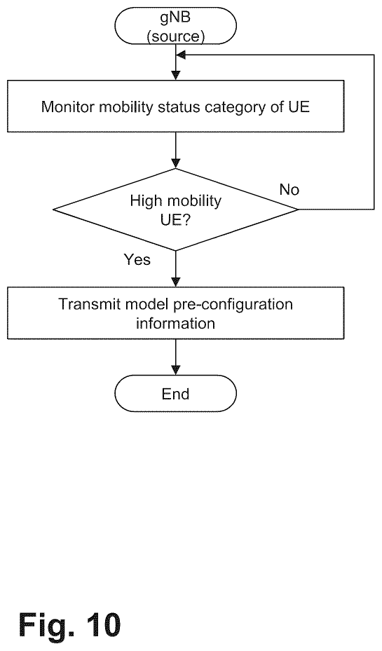

FIG. 10 shows a flow chart of UE mobility detection. When gNB determines model pre-configuration to UE, there are mixture of scenarios with combination of different criteria to decide pre-configure UE model. As an example, by monitoring mobility status of UEs, source gNB determines “high mobility” UE who will be indicated for model re-configuration (based on AI/ML model repository from network) in preparation for handover to other target gNB. How to determine high mobility UE for early model operation change with model re-configuration depends on network-specific implementation. However, those UEs can be identified using mobility pattern information with historical measurement data, for example.

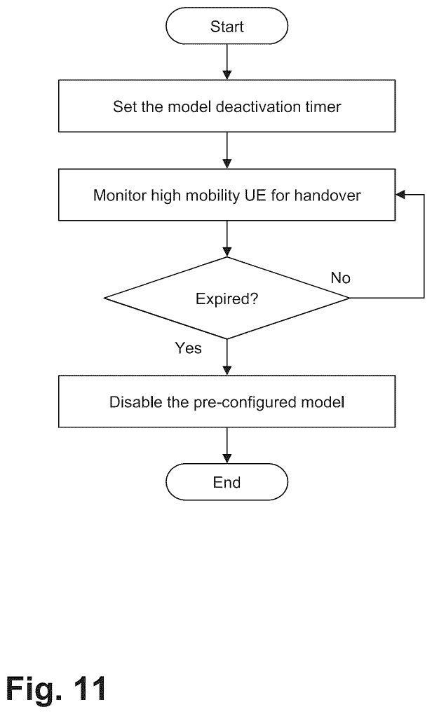

FIG. 11 shows a flow chart of UE mobility monitoring. For high mobility UE with the pre-loaded model re-configuration, the model deactivation timer is applied so that network/device resource can be less burdened when handover does not occur. With the expiry of the model deactivation timer, high mobility UE unloads the pre-configured model as this UE makes no handover.

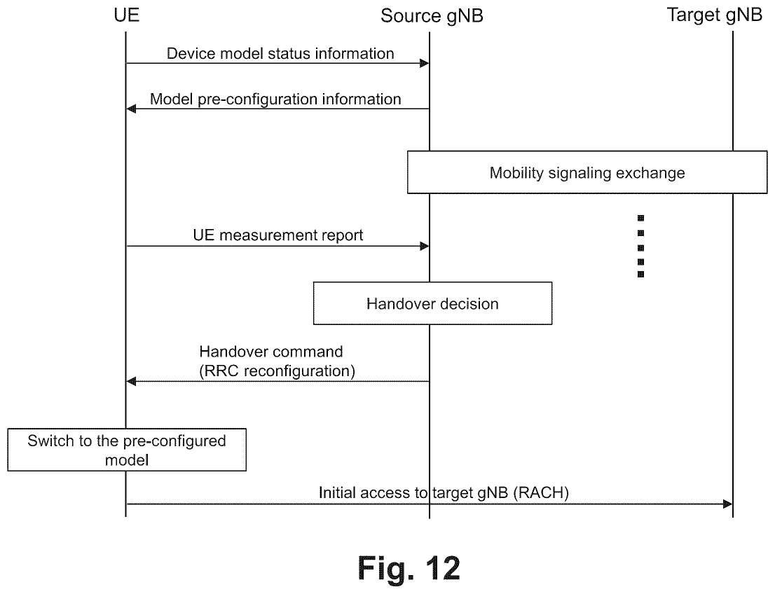

FIG. 12 describes a signaling flow of pre-configured model for general handover case. For the pre-configured model with UE mobility, both general handover and advanced handover scenarios can be applied. Firstly, for general/normal handover case, RRC reconfiguration through handover command signaling indicates target gNB information by triggering activation of the pre-configured model and additional model pre-configuration information if necessary. After confirming handover, the pre-configured model is enabled beforehand for connection with target gNB.

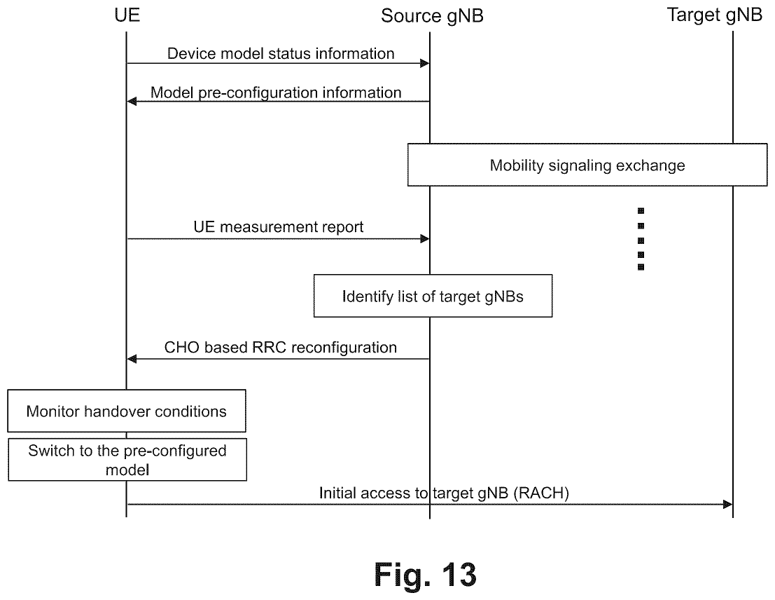

FIG. 13 describes a signaling flow of pre-configured model for conditional handover (CHO) case. This is for advanced handover case (e.g., conditional handover—CHO). In source gNB, candidate target gNBs are prioritized for UE connection in advance so that any model-related signaling overhead and UE mobility-based model impact can be minimized. CHO based RRC reconfiguration signaling indicates additional new information about additional model pre-configuration information associated with the prioritized list of target gNBs. After CHO condition is met, the pre-configured model is enabled beforehand for connection with target gNB. However, a set of resources need to be reserved in target gNBs during UE mobility execution with model support and source gNB maintains the prioritized list of target gNBs and the associated model pre-configuration instruction to be signaled to high mobility UE.

This application provides fundamental mechanisms of interworking and data information flow in radio access network collaboration for AI/ML support, especially in UE mobility aspect.

Based on the proposed invention, gNB-UE behaviors for supporting AI/ML operation for wireless communication with UE mobility can be greatly improved with the potential scenarios.

1. A method of gNB-UE behaviors for model-based mobility with a pre-configuring AI/ML model based on either full pre-configuration or partial pre-configuration, wherein
for full pre-configured AI/ML model, the re-configured model is fully loaded to UE before handover execution,
for partial pre-configuration of AI/ML model, the re-configured model is partially loaded to UE before handover execution.

2. The method according to claim 1, where determination of transmitting full or partial model pre-configuration information is based on network/UE-specific criteria.

3. The method according to claim 1, wherein network/UE-specific criteria are UE ML capability state and/or model type and/or functionalities, and/or network data traffic status and/or model-based service application.

4. The method according to claim 1, wherein source gNB gets the latest information about UE model operation so that any required model re-configuration between gNB and UE is made by obtaining the model operation status updates from UE with device model status information signaling.

5. The method according to claim 1, wherein device model status information contains the categorized data types like model operation mode state and/or model training state and/or model inference state and/or model update state and/or model monitoring state and/or model ID and/or ML capability state and
the structure of device model status information is flexibly configured or sub-categorized through RRC signaling.
device model status information is sent to gNB from UE through PUCCH/PUSCH or MAC CE.

6. The method according to claim 1, wherein UE pre-loads the re-configured model in advance for new connection with target gNB based on the received signaling of model pre-configuration information from source gNB.

7. The method according to claim 1, model pre-configuration information contains such as model configuration parameters, model ID, model transfer type, model lifecycle type, whereby model pre-configuration information is sent to UE from gNB through PDCCH/PDSCH or MAC CE.

8. The method according to claim 1, wherein model pre-configuration information can be structured into multiple partitions so that partial/fractional re-configuration can be applied well as full re-configuration for pre-loading.

9. The method according to claim 1, wherein based on the content of model pre-configuration information, those can be partitioned into common attributes and UE-specific attributes so that any combination of model pre-configuration information can be provided to UE if necessary.

10. The method according to claim 1, wherein a super set of model pre-configuration information is maintained in source gNB or network side.

11. The method according to claim 1,
wherein different levels of model re-configuration is performed based on different conditions and environments of model operation.

12. The method according to claim 1, wherein the necessity of UE model re-configuration is determined depending on location of model activation (e.g., network side or UE side or both).

13. The method according to claim 1, wherein location of model activation is on network side and/or UE side.

14. The method according to claim 1, wherein for model in network side only, no UE model re-configuration is executed and assistance information signaling from UE might be still needed. Model re-configuration request need to be sent to target gNB(s) or network side.

15. The method according to claim 1, wherein for model in UE side only or models in network-UE sides, full or partial/fractional re-configuration to UE model is executed. Model re-configuration request also is to be sent to target gNB(s) or network side when there is a model activation in network side for re-configuration.

16. The method according to claim 1, wherein source gNB determines high mobility-UE, which will be indicated for model re-configuration, which is based on AI/ML model repository from network in preparation for handover to other target gNB by monitoring mobility status of UEs and high mobility-UEs are identified using mobility pattern information with historical measurement data.

17. The method according to claim 1, wherein for high mobility UE with the pre-loaded model re-configuration, the model deactivation timer is applied so that network and/or UE resource is less burdened when handover does not occur.

18. The method according to claim 1, wherein with the expiry of the model deactivation timer, high mobility UE unloads the pre-configured model as this UE makes no handover.

19. The method according to claim 1, for general/normal handover case, RRC reconfiguration through handover command signaling indicates target gNB information by triggering activation of the pre-configured model and additional model pre-configuration information, if necessary, after confirming handover the pre-configured model is enabled beforehand for connection with target gNB.

20. The method according to claim 1, wherein for advanced handover case (conditional handover—CHO), in source gNB, candidate target gNBs are prioritized for UE connection in advance so that any model-related signaling overhead and UE mobility-based model impact is minimized.

21. The method according to claim 1, wherein CHO based RRC reconfiguration signaling indicates additional new information about additional model pre-configuration information associated with the prioritized list of target gNBs.

22. The method according to claim 1, wherein after CHO condition is met, the pre-configured model is enabled beforehand for connection with target gNB.

23. The method according to claim 1, wherein a set of resources need to be reserved in target gNBs during UE mobility execution with model support and source gNB maintains the prioritized list of target gNBs and the associated model pre-configuration instruction to be signaled to high mobility UE.

24. A wireless device comprising at least one memory and at least one processor configured to carry out a method according to claim 1.

25. A user equipment, UE, comprising a wireless device according to claim 24.

26. A base station, BS, comprising at least one memory and at least one processor configured to carry out a method according to claim 1.

27. A wireless communication system comprising:
at least one base station comprising at least one memory and at least one processor configured to carry out a method of gNB-UE behaviors for model-based mobility with a pre-configuring AI/ML model based on either full pre-configuration or partial pre-configuration,
wherein for full pre-configured AI/ML model, the re-configured model is fully loaded to UE before handover execution, and
wherein for partial pre-configuration of AI/ML model, the pre-configured model is partially loaded to UE before handover execution;
and at and at least one user equipment according to claim 25.

28. A non-transitory computer program product comprising instructions which, when executed by at least one processor, configure said at least one processor to carry out a method according to claim 1.
